(19) United States
(12) Patent Application Publication
(10) Pub. No.: US 2020/0164475 A1
(43) Pub. Date: May 28, 2020

(54) MILLING TOOL DEVICE FOR AUXILIARY CHIP BREAKING AND TOOL SYSTEM FOR AUXILIARY CHIP BREAKING UNDER DIFFERENT LUBRICATING CONDITIONS

(71) Applicants: QINGDAO UNIVERSITY OF TECHNOLOGY, QINGDAO (CN); CHONGQING UNIVERSITY, CHONGQING (CN); SHANGHAI JINZHAO ENERGY SAVING TECHNOLOGY CO., LTD, SHANGHAI (CN)

(72) Inventors: Changhe LI, QINGDAO (CN); Qingan YIN, QINGDAO (CN); Huajun CAO, QINGDAO (CN); Wenfeng DING, QINGDAO (CN); Naiqing ZHANG, QINGDAO (CN); Yonghong LIU, QINGDAO (CN); Xiufang BAI, QINGDAO (CN); Lan DONG, QINGDAO (CN); Zhenjing DUAN, QINGDAO (CN); Yanbin ZHANG, QINGDAO (CN); Menghua SUI, QINGDAO (CN); Wentao WU, QINGDAO (CN); Teng GAO, QINGDAO (CN); Min YANG, QINGDAO (CN); Dongzhou JIA, QINGDAO (CN); Runze LI, QINGDAO (CN); Yali HOU, QINGDAO (CN)

(73) Assignees: QINGDAO UNIVERSITY OF TECHNOLOGY; CHONGQING UNIVERSITY; SHANGHAI JINZHAO ENERGY SAVING TECHNOLOGY CO., LTD

(21) Appl. No.: 16/683,454

(22) Filed: Nov. 14, 2019

(30) Foreign Application Priority Data
Nov. 22, 2018 (CN) 201811399655.5

(51) Int. Cl. B23Q 11/10; B23C 1/06; B23Q 3/157; B23Q 3/155

(52) U.S. Cl. CPC B23Q 11/10; B23C 1/06; B23Q 3/15722; B23Q 2003/155446; B23C 2250/12; B23Q 2003/155418; B23Q 2003/155428; B23Q 3/1554

(57) ABSTRACT

The present invention discloses a tool device for auxiliary chip breaking and a tool system for auxiliary chip breaking under different lubricating conditions, which solves the problem that long chips affect the surface quality of a workpiece in the prior art and has the beneficial effects of realizing chip breaking and wide scope of application. The solution of the present invention is as follows: the tool device for auxiliary chip breaking includes a cutting mechanism for cutting the workpiece, arranged above the workpiece; a tool magazine mechanism, including a first rotating mechanism and a plurality of tools connected with the first rotating mechanism; and a tool changing mechanism, including a second rotating mechanism and manipulators connected with the second rotating mechanism, and arranged between the tool magazine mechanism and the cutting mechanism.

### CROSS-REFERENCE TO RELATED APPLICATIONS

This application claims priority to Chinese Patent Application No. 201811399655.5 with a filing date of Nov. 22, 2018. The content of the aforementioned applications, including any intervening amendments thereto, are incorporated herein by reference.

### TECHNICAL FIELD

The present invention relates to the field of machining, and particularly relates to a tool device for auxiliary chip breaking and a tool system for auxiliary chip breaking under different lubricating conditions.

### BACKGROUND OF THE PRESENT INVENTION

Currently, milling machining is cutting machining which is the most commonly used in the mechanical manufacturing industry, and has high machining production efficiency, wide machining range and high machining precision. However, during milling, the time that a tool comes into contact with a workpiece is very short; a sever friction occurs between a rake face of the, tool and chips and between a flank face and the workpiece, which generates a lot of cutting heat, causing the sharp wear of the tool, and consequently, the tool fails fast, thereby seriously restricting the improvement of machining efficiency. With the increase of cutting speed, a milling force is reduced. Since the discharge speed of chips along the rake face of the tool is fast, which takes away a lot of cutting heat (about 90%), the heat transferred to the workpiece is substantially reduced, which is of enormous significance to reduce the internal stress and thermal deformation of the workpiece and improve the machining precision of parts. Meanwhile, the most common chip shape in the cutting process is a continuous chip. Such type of chip has small influence of fluctuation on the cutting force due to relatively smooth free surface and bottom surface of the chip. Therefore, the cutting process is relatively stable. A shearing chip is also called a segmental chip; the free surface is sawtooth; and then, the sliding surfaces of the chip are not completely separated, and the cutting force may generate certain fluctuation. A unit chip is also called a granular chip and is formed by continuing to slide a shearing surface based on the shearing chip until separated and broken; and the cutting force has a large fluctuation. When brittle materials are machined, brittle fracture occurs in the metal on a cutting layer without plastic deformation, thereby generating crack ships with irregular shapes, causing an uneven machining surface. Therefore, in the case that the cutting conditions and cutting parameters are changed, the chip shape may change, and meanwhile, the problem of no chip breaking or excessive chip breaking often occurs, and unbroken disorderly chips scrap the machined surface, causing the fault of a machine tool spindle, and even causing the production safety problems and low production efficiency. Therefore, grasping the change rules of the chips is beneficial to control the size and shape of the chips, and then, the purpose of safety production is achieved and the prediction of machining quality is realized by chip breaking.

Through retrieval, Tao Chen, et al., from Harbin University of Science and Technology, invented a compound spiral annular tool with a non-equidistant damping tank structure and a processing method (patent No.: ZL 201410223987.3), including: an annular tool handle, which is characterized in that: a radial cooling channel and an axial cooling channel are provided in the annular tool handle and used for cooling and cleaning a spiral cutting structure with the damping tank and a fillet cutting structure; the damping tank included in the spiral cutting structure is distributed on the spiral cutting structure in an unequal radial distance manner, thereby realizing efficient chip breaking, reducing the cutting vibration arising from the continuous chip impact, and realizing stable cutting.

Through retrieval, Zongchao Zhang, et al., from Beijing Worldia Diamond Tools Co., Ltd., invented a chip-breaking groove tool and a processing method (patent No.: ZL 201610498818.X), which is characterized in that a tool head is welded at a corner of a tool base, and has the sizes: a rake angle of 5° to 5°, and a chamfer angle of −45° to 20°; a chip breaking angle of 90° to 120°; a cutting edge width of 0.02 mm to 0.15 mm, a chamfer width of 0.02 mm to 0.1 mm, a chip-breaking groove width of 0.1 mm to 5 mm, and an angle of groove width variation of −15° to 15°; a chip-breaking groove depth of 0.05 to 0.45; and the cross-section shape of the chip-breaking groove is a circular-arc shape, and the width of the circular arc is gradually changed. Its advantage is that the matching and applicability of a blade of the chip-breaking groove are substantially improved, and the blade can cope with various chip breaking processing conditions.

Through retrieval, Zongchao Zhang, et al., from Beijing Worldia Diamond Tools Co., Ltd., invented a reducing chip breaker tool (patent No.: ZL 201721178110.2). A tool head of the tool is welded at a corner of a blade, and provided with a tool nose; a first chip breaker and a second chip breaker are respectively provided on the surfaces of the tool head, namely, both sides of the tool nose; and a sleeking blade bulge is formed at the side surface of the tool head. The efficient continuous chip breaking and precision sleeking can be integrated, and the integration of finish machining+chip breaking machining sleeking processing is realized by adding a new structure.

Through retrieval, S. K. Nagarajan, et al., from Cobalt-Tungsten Carbide Hard Alloy India Co., Ltd., invented a cutting blade with enhanced chip breaking performance (patent No. ZL 201510159673.6). The body of the blade is provided with an upper surface, a lower surface, a plurality of flat flank faces, a two-way acute-angled cutting angle that connects two adjacent flank faces and a two-way obtuse-angled cutting angle. A facet has a varying width. An annular land includes a plurality of raised extending parts, relatively long and narrow chip breaking points close to the acute-angled cutting angle and relatively short and wide chip breaking points close to the obtuse-angled cutting angle. Chip breaking slope surfaces are located at the sides of each of the relatively long and narrow chip breaking points and each of the relatively short and wide chip breaking points. The chip breaking slope surfaces form a series of non-collinear lines to realize the function of enhancing the chip breaking performance.

Through retrieval, Jianzhao, Wu, from Ningbo University, invented a chip breaking device of a super hard lathe tool (patent No.: ZL 201610082963.X), which is characterized in a chip breaking block and a blade pressing plate which is fixedly installed on a handle; the chip breaking block is located on the upper end surface of the blade; the blade is fixed to the handle; and a chip breaking block fixing device without changing an original structure of the lathe tool is arranged on the chip breaking block. The chip breaking device has the advantages that the chip breaking device fixes the chip breaking block on the upper end surface of the blade by using a bolt and the blade pressing plate of the super hard lathe tool for fixing the blade, which realizes the chip breaking function of the super hard lathe tool, and needs not to change the original structure of the super hard lathe tool. Moreover, the positioning and clamping of the chip breaking block are reliable; the dismounting and use are convenient; the structure is simple; and the cost is low.

Through retrieval, Yaonan Cheng, from Harbin University of Science and Technology, invented a heavy cutting blade with double chip breaking structures (patent No.: 201410138221.5). A linear cutting edge is processed at an outer edge of a rake face of the blade; a plurality of oval bulges are slantly arranged on the rake face; a graded slot is processed in the middle of each side surface of a square platform at the top of the blade; a bump is arranged in the graded slot; circular-arc convex columns are arranged at the top of the bump in parallel; side surfaces located at both sides of the graded slot on the square platform are convex spherical surfaces; a square heat dissipation slot is formed in the middle of the bottom surface of the blade; the bottom surface of the blade on the periphery of the square heat dissipation slot is divided into eight supporting surfaces; and a U-shaped heat dissipation slot communicated with the square heat dissipation slot is formed among every two adjacent supporting surfaces and the supporting surface located between the two adjacent supporting surfaces. The blade can solve the problem of difficult chip breaking in the cutting machining of a water chamber seal head.

Through retrieval, an experimental system of milling under different lubricating conditions or a tool designed from the perspective of chip breaking is not provided at present.

### SUMMARY OF PRESENT INVENTION

To overcome the deficiencies in the prior art, the present invention provides a tool device for auxiliary chip breaking. The device mills a workpiece by using a cutting mechanism, wherein a manipulator clamping tool in a tool changing mechanism can realize the function of auxiliary chip breaking, and a tool magazine mechanism realizes the storage of a tool and can realize the selection of a plurality of tools.

The specific solution of the tool device for auxiliary chip breaking is as follows:

A tool device for auxiliary chip breaking includes:

a cutting mechanism for cutting a workpiece, located above the workpiece;

a tool magazine mechanism, including a first rotating mechanism and a plurality of tools connected with the first rotating mechanism; and

a tool changing mechanism, including a second rotating mechanism and manipulators connected with the second rotating mechanism, and arranged between the tool magazine mechanism and the cutting mechanism, wherein the manipulators can be moved to select the tools from the tool magazine mechanism and clamp the tools to cut off chips generated by the cutting mechanism to cut the workpiece.

In the device, the cutting mechanism processes the workpiece, and the tool changing mechanism rotates through a manipulator clamping tool of the tool changing mechanism to cut off the chips generated by cutting the workpiece. Since the chip has at least one type, the tool magazine mechanism is provided with a plurality of tools for the tool changing mechanism to select a suitable tool.

Further, the second rotating mechanism is connected with a moving mechanism, and the moving mechanism drives the second rotating mechanism and then drives the manipulators to do reciprocating motion towards the tool magazine mechanism. The moving mechanism is a linear reciprocating motor or an electric push rod, and an end of the push rod is connected with the second rotating mechanism.

Or, in another solution, the second rotating mechanism is arranged in a motor box; the motor box is arranged on a bracket; the bracket provide support by a machine tool: and the motor box can do the reciprocating motion relative to the bracket, thereby driving the manipulators to do the reciprocating motion towards the tool magazine mechanism. Specifically, a chute is arranged on the bracket; the motor box is partially inserted into the chute; and a linear reciprocating pushing mechanism is arranged at one side of the motor box, and the motor box is pushed to do the reciprocating motion through the pushing mechanism.

Further, the tool magazine mechanism includes a tool pan; a plurality of first split rings are arranged in a circumferential direction of the tool pan; the tool is supported by the tool pan through the first split rings; the tools arranged in the plurality of first split rings have the same and/or different structure(s), and the length and size of the tool can also be set to be different.

Further, two manipulators are arranged reversely, and the two manipulators are arranged horizontally; the middle sections of the two manipulators are connected, and also connected with the second rotating mechanism through a connecting shaft; and the set height of the manipulators is the same as the height of the tool pan, so as to clamp the tools.

The manipulators are provided with second split rings to match with the tool; a first half section of the tool is in a circular table shape; a convex part is arranged in the middle section of the tool; a clamping slot is formed in a circumferential direction of the convex part; and the tool is matched with the first split ring or the second split ring through the clamping slot. In this way, the tool changing mechanism can clamp the set tools from the tool magazine mechanism, and can also deliver the tools to the tool pan of the tool magazine mechanism, and then select new tools. Specifically, the tools can be selected by manually operating the tool magazine mechanism and the tool changing mechanism or through a controller.

Further, the tool magazine mechanism and the cutting mechanism are supported by the bracket.

Further, the tool is a first tool with a chip breaking edge, and an angle formed by a flank face of the chip breaking edge and a main cutting edge of a second tool of the cutting mechanism is in direct proportion to a rake angle of the second tool.

The radius of a chip-curling surface of the chip breaking edge of the first tool is inversely proportional to the brittleness of workpiece material. Therefore, the corresponding tools are selected according to the material characteristics of the workpiece.

Further, a shear angle φ between a shearing surface of the workpiece and a cutting speed direction can be determined by the following formula:

$$φ = arc tan \frac{cos {γ}_{0}}{ξ - sin {γ}_{0}}$$

wherein ξ is the deformation coefficient of the material, and γ₀ is the rake angle of the second tool.

The cutting mechanism can realize up-and-down motion relative to the bracket. Specifically, the cutting mechanism is driven by a vertical driving mechanism to realize such motion, and the workpiece is cut by cooperating with motion of a third rotating mechanism in the cutting mechanism.

To overcome the deficiencies in the prior art, the present invention further provides a tool system for auxiliary chip breaking under different lubricating conditions, including the tool device for auxiliary chip breaking;

a workbench, configured to fix the workpiece and arranged below the cutting mechanism;

a nozzle, arranged at the side of the second tool of the cutting mechanism; and

a lubricating mechanism, connected with the nozzle to provide lubricating oil.

Further, the lubricating mechanism includes a lubricating pump; the lubricating pump is connected with an oil cup and connected with a gas source processor through a solenoid valve; and the gas source processor is provided with an air inlet interface.

A frequency generator is arranged between the solenoid vale and the lubricating pump to control the frequency of gas inputted from the air inlet interface.

Further, the nozzle is connected with a nozzle pipeline; the nozzle pipeline is connected with a lubricating oil pipeline through a nozzle interface; and a fixing cover is arranged at one side of the cutting mechanism through a sucker.

The nozzle axis has an angle of 40°-50° with a workbench surface; the nozzle has a distance of 20 to 30 mm, from the surface of the installed workpiece; and the arrangement position of the nozzle is beneficial to increase the proportion that the cutting fluid enters a processing zone, thereby improving the cooling and lubricating effects.

The cutting mechanism includes a motor box; the third rotating mechanism is arranged in the motor box to drive the second tool to rotate; and the sucker is arranged at the side of the motor box.

Further, the workbench surface is provided with a workpiece clamp; workpiece clamp opening is used for arranging the clamping slot of the workpiece; and a clamp screw is arranged at the side of the workpiece clamp to limit the workpiece.

A pressing plate is arranged at the side of the clamping slot of the workpiece clamp, and can realize the rotation relative to the workpiece clamp.

A locating block is movably arranged in the clamping slot and can be arranged at one side of the workpiece, wherein the locating block can be arranged, at one side of the workpiece in which the clamping slot is arranged; a through'hole or a blind hole is formed in the locating block; and the clamp screw is abutted against the workpiece across the through hole or the blind hole of the locating block.

Further, a dynamometer is arranged below the workpiece clamp, arranged between the workpiece clamp and the workbench, connected with a controller, and constitutes a force measuring mechanism with a force information collector.

The controller is connected with a temperature sensor; the workpiece is provided with the blind hole so that the temperature sensor can be installed on the workpiece; the temperature sensor is a thermocouple; and a plurality of thermocouples can be arranged, so as to ensure the accuracy of measured data.

In addition, to realize the automatic tool changing, the cutting mechanism, the first rotating mechanism, the second rotating mechanism and the moving mechanism are individually connected with the controller respectively; and the controller is a PLC with an operation screen, so as to control the actions of the mechanisms according to set procedures.

Compared, with the prior art, the present invention has beneficial effects that:

1) By arranging the tool device, the present invention not only can process the workpiece, but also can cut off longer chips, thereby reducing the damage of the longer chips to the tool surface and the workpiece surface and improving the processing quality and tool life.

2) By arranging the tool magazine mechanism and the tool changing, mechanism, the present invention can use different tools with regard to different chips, thereby expanding the application scope of the whole tool device.

3) By arranging the lubricating mechanism, the present invention can realize the milling under dry cutting, casting type lubrication, minimum quantity lubrication (MQL) and nanofluid minimum quantity lubrication (NMQL) conditions, and can realize the measurement of milling force and temperature during milling.

### DESCRIPTION OF THE DRAWINGS

Drawings of the description forming part of the present application, are used for providing further understanding for the present application, and the exemplary embodiments of the present application and description thereof are used for explaining the present application, and do not form improper limitation to the present application.

FIG. 1 is an axonometric drawing of a tool for auxiliary chip breaking under different lubricating conditions and an experimental system;

FIG. 2 is an exploded assembly drawing of a lubricating mechanism;

FIG. 3 is an axonometric drawing of a tool magazine mechanism;

FIG. 4 is a top view of a tool pan;

FIG. 5(a) is an axonometric drawing of a first mandrel;

FIG. 5(b) is a front view of a first mandrel;

FIG. 6 is an axonometric drawing of a tool changing mechanism;

FIG. 7 is an axonometric drawing of a cutting mechanism;

FIG. 8 is an axonometric drawing of a force measuring mechanism;

FIG. 9 is a locating and clamping diagram of a workpiece;

FIG. 10 is an axonometric drawing of a milling dynamometer;

FIG. 11 is a schematic diagram of temperature measurement;

FIG. 12 is a section view of a workpiece;

FIG. 13 is a three-dimensional diagram of a tool with a chip breaking edge;

FIG. 14 is a section view of a tool in Embodiment 1 of a chip breaking edge;

FIG. 15 is a schematic diagram in Embodiment 1 of a chip breaking edge;

FIG. 16 is a section view of a tool in Embodiment 2 of a chip breaking edge;

FIG. 17 is a schematic diagram in Embodiment 2 of a chip breaking edge;

FIG. 18 is a diagram of a metal cutting deformation zone;

FIG. 19 is a schematic diagram of a shear zone;

FIG. 20 is a diagram for stress analysis of a shear zone;

FIG. 21 is a diagram of a velocity model; and

FIG. 22 is a schematic diagram of a milling air flow field.

In the drawings, lubricating mechanism I, tool magazine mechanism II, tool changing mechanism III, cutting mechanism IV, force measuring mechanism V, box body I-1, oil cup joint I-2, oil cup I-3, fixing screw I-4, washer I-5, fixing screw I-6, lubricating pump fixing cover I-7, precision MQL pump I-8, air flow regulation knob I-9, tee I-10, solenoid valve I-11, gas source processor I-12, air inlet interface I-13, two-way joint I-14, frequency generator I-15, pipeline I-16, pipeline I-17, pipeline I-18, oil regulation knob I-19, and lubricating pump outlet joint I-20.

First motor box II-1, first mandrel II-2, tool pan II-3, tool II-4, first split ring II-5, convex, part II-6, and clamping slot II-7.

Second motor box III-1, first manipulator III-2, second manipulator III-3, and second split ring III-4.

Third motor box IV-1, lubricating, oil pipeline IV-2, screw IV-3, washer IV-4, magnetic chuck IV-5, nozzle interface IV-6, nozzle pipe IV-7, second mandrel IV-8, nozzle IV-9, second tool IV-10, chip groove IV-10-1, chip breaking edge IV-10-2, chip breaking edge IV-10-3, rake face IV-10-4 of chip breaking edge, flank face IV-10-5 of chip breaking edge, rake face IV-10-6 of main cutting edge, tool nose IV-10-7, flank face IV-10-8 of main cutting edge, chip-curling surface IV-10-9 of chip breaking edge, and workbench IV-11.

Computer V-1, wire V-2, force information collector V-3, amplifier V-4, pressing plate V-5, cylindrical gasket V-6, pressing plate nut V-7, pressing plate screw V-8, workpiece V-9, flat plate screw V-10, small pressing plate screw V-11, locating screw V-12, workpiece clamp V-13, locating block V-14, dynamometer V-15, screw V-16, clamp screw V-17, flat plate V-18, and flat plate V-19.

Thermocouple VI-1, thermocouple 1 VI-1-1, thermocouple 2 VI-1-2, thermocouple 3 VI-1-3, information collector VI-2, and computer VI-3.

### DETAILED DESCRIPTION OF PREFERRED EMBODIMENTS

It should be pointed out that, the following detailed description is exemplary and aims at providing further description to the present application. All technical and scientific terms used herein have the same meanings as those usually understood by those ordinary skilled in the art of the present application, unless otherwise specified.

It should be noted that, the terms used herein are only used for describing specific implementation, not intended to limit the exemplary implementation according to the present application. As used herein, a singular form is also intended to include a plural form, unless otherwise clearly specified in the context. In addition, it should be understood that, when the terms “contain” and/or “include” are/is used in the description, it specifies the existence of features, steps, operation, devices, components and/or their combinations.

As introduced in the background of the present invention, in view of the deficiencies in the prior art, in order to solve the above technical problems, the present application proposes a tool device and method for auxiliary chip breaking.

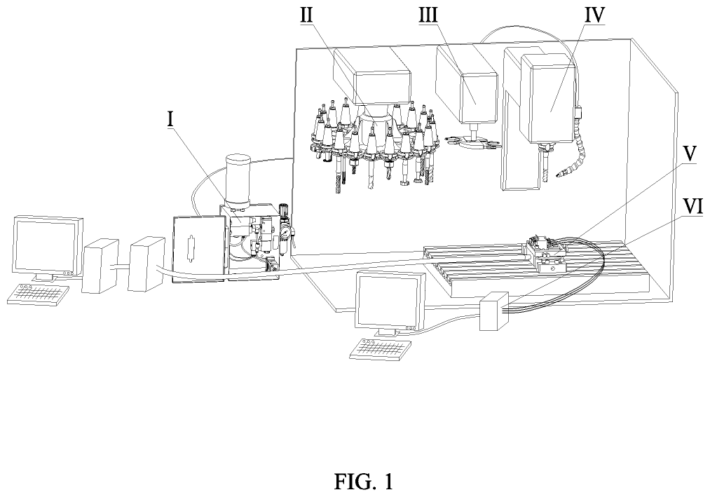

As shown in FIG. 1, the tool device for auxiliary chip breaking in the present invention includes a cutting mechanism IV for cutting a workpiece, arranged above the workpiece; a tool magazine mechanism II, including a first rotating mechanism and a plurality of tools connected with the first rotating mechanism; and a tool changing mechanism III, including a second rotating mechanism and manipulators connected with the second rotating mechanism, and arranged between the tool magazine mechanism II and the cutting mechanism, wherein the manipulators can be moved to select the tools from the tool magazine mechanism II and clamp the tools to cut off the chips generated by the cutting mechanism IV to cut the workpiece.

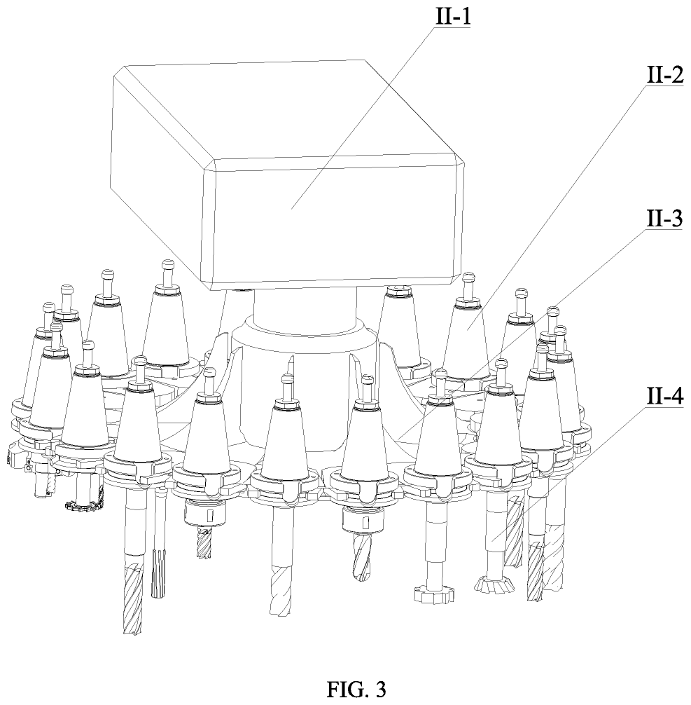

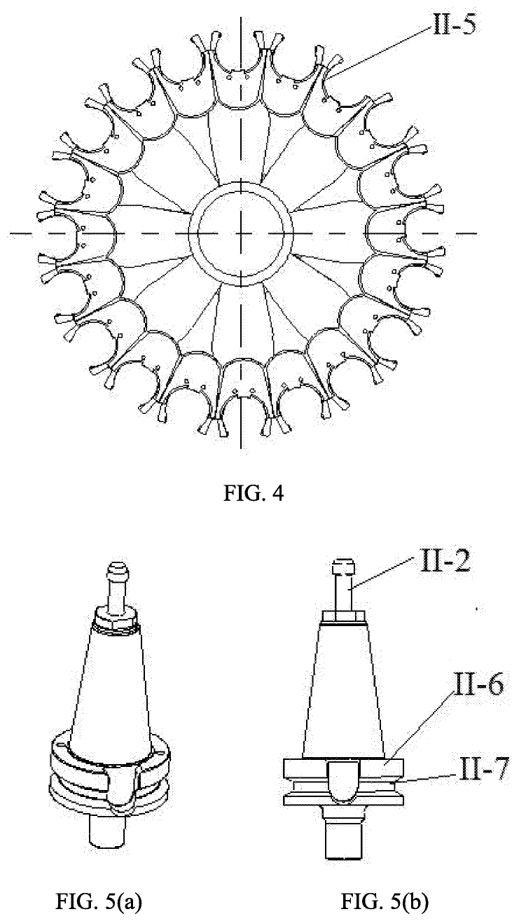

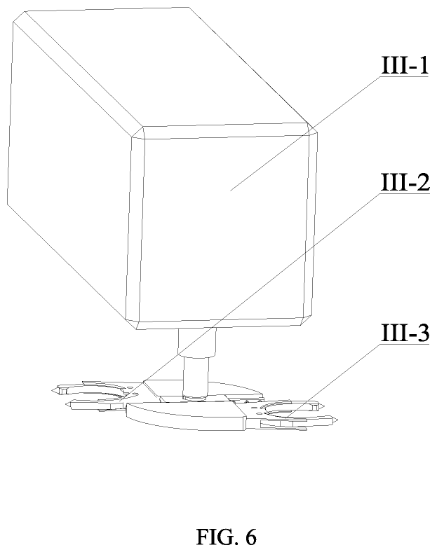

FIG. 3 is an axonometric drawing of a tool magazine mechanism; FIG. 4 is a top view of a tool pan; FIG. 5(a) and FIG. 5(b) are respectively an axonometric drawing and a front view of a first mandrel; and FIG. 6 is an axonometric drawing of a tool changing mechanism.

Description is made in combination with FIGS. 3-6. A first motor box II-1 realizes the rotation of a tool pan II-3 through an internal structure, and then, drives a first mandrel II-2 and a tool II-4 on the tool pan II-3 to rotate; and a second motor box III-1 realizes location transformation of a first manipulator III-2 and a second manipulator III-3 through an internal structure, and then, realizes the swapping of a processing tool, which can select different tools for processing according to the different conditions.

The second rotating mechanism is arranged in the second motor box III-1; the second motor box III-1 is arranged on a bracket; the bracket provides support by a machine tool; and the second motor box III-1 can do the reciprocating motion relative to the bracket, and then drives the two manipulators to do the reciprocating motion towards the tool magazine mechanism. Specifically, a chute is arranged on the bracket; the second motor box III-1 is partially inserted into the chute; and a linear reciprocating pushing mechanism is arranged at one side of the second motor box III-1, and the motor box is pushed to do the reciprocating motion through the pushing mechanism.

The tool magazine mechanism II includes a tool pan II-3; a plurality of first split rings II-5 are arranged in a circumferential direction of the tool pan II-3; the tool is supported by the tool pan II-3 through the first split rings II-5; the tools arranged in the plurality of first split rings II-5 have the same and/or different structure(s), and the length and size of the tool can also be set to be different.

Two manipulators are arranged reversely, and the two manipulators are arranged horizontally; the middle sections of the two manipulators are connected and connected with the second rotating mechanism through a connecting shaft.

Each of the manipulators is provided with a second split ring III-4 to match with the tool; the tool includes the first mandrel II-2 and a first tool connected with the first mandrel II-2 and having a chip breaking edge; a first half section of the first mandrel is in a circular table shape; a convex part II-6 is arranged in the middle section of the first mandrel; a clamping slot II-7 is formed in a circumferential direction of the convex part II-6; and the tool is matched with a first split ring II-5 or a second split ring III-4 through a clamping slot II-7. In this way, the tool changing mechanism can clamp the set tools from the tool magazine mechanism, and can also deliver the tools to the tool pan II-3 of the tool magazine mechanism, and then, select new tools. Specifically, the tools can be selected by manually operating the tool magazine mechanism and the tool changing mechanism or through a controller.

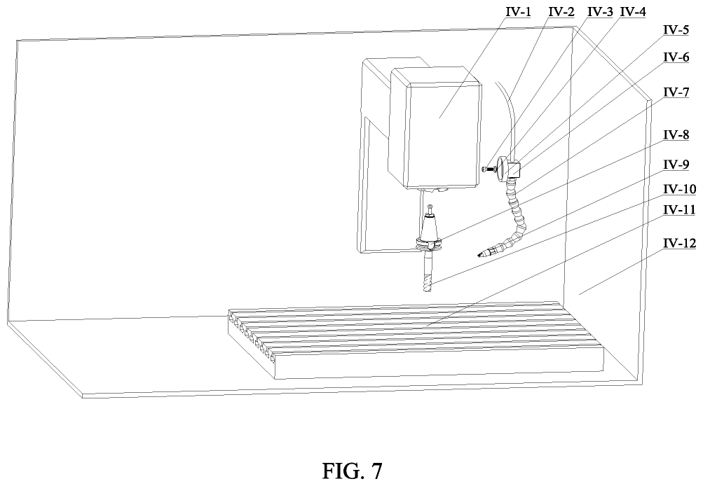

FIG. 7 is an axonometric drawing of a cutting mechanism. A third motor box IV-1 realizes the rotation of a second mandrel IV-8 through an internal structure, and then, drives a second tool IV-10 to rotate, thereby realizing the cutting. The lubricating oil provided by the, lubricating mechanism I is sprayed to a cutting zone through a lubricating oil pipeline IV-2, a nozzle pipe IV-7 and a nozzle IV-9, and a magnetic chuck IV-5 is fixed with a nozzle interface IV-6 through a screw IV-3 and a washer IV-4 and is sucked on a box body of the motor box IV-1.

A tool system for auxiliary chip breaking under different lubricating conditions includes the tool device for auxiliary chip breaking; a workbench IV-11, configured to fix the workpiece, and arranged below the cutting mechanism IV; a nozzle, arranged at the side of the second tool of the cutting mechanism; and a lubricating mechanism I, connected with the nozzle to provide lubricating oil.

As shown, in FIG. 1, the lubricating mechanism I provides the lubricating oil for milling to cool and lubricate; the tool magazine mechanism II realizes the storage of the tool; the tool changing mechanism III realizes the swapping of the tools; the cutting mechanism IV is used for milling the workpiece; and a force measuring, mechanism IV mainly measures the milling force when the workpiece is milled.

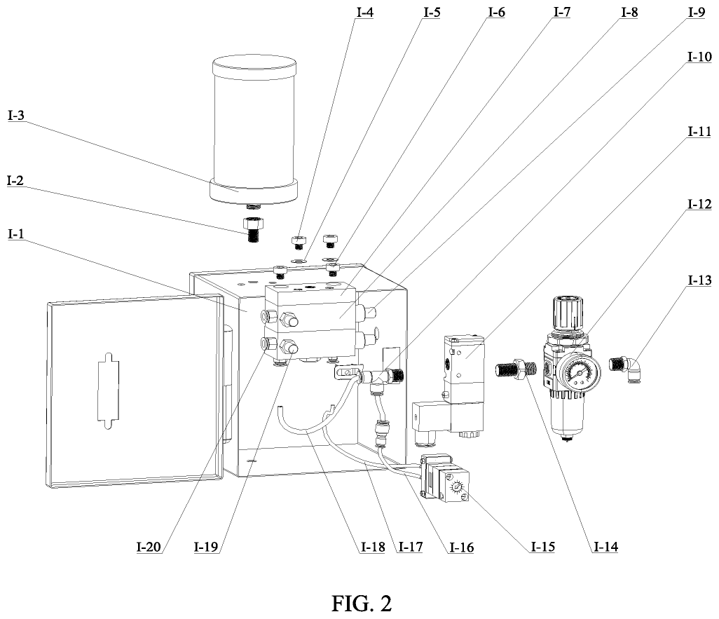

FIG. 2 is an exploded assembly drawing of a lubricating mechanism.

As shown in FIG. 2, the lubricating mechanism includes a box body I-1, an oil cup joint I-2, an oil cup I-3, a fixing screw I-4, a washer I-5, a fixing screw I-6, a lubricating pump fixing cover I-7, a precision MQL pump I-8, an air flow regulation knob I-9, a tee I-10, a solenoid valve I-11, a gas source processor I-12, an air inlet interface I-13, a two-way joint 1-14, a frequency generator I-15, a pipeline I-16, a pipeline I-17, a pipeline I-18, an oil regulation knob I-19, and a lubricating pump outlet joint I-20.

The air inlet interface I-13 is fixed to the gas source processor I-12, and high-pressure gas enters the gas source processor I-12 through the air inlet interface I-13 to filter, thereby providing the high-pressure gas for the lubricating mechanism. The gas source processor I-12 is connected with the solenoid valve I-11 through the two-way joint I-14 to control the entry of the gas; a tee I-10 is connected at the outlet of the solenoid valve I-11; the high-pressure gas enters the frequency generator I-15 through the outlet pipeline I-16 of the tee I-10; the input frequency of the gas is controlled through the frequency generator I-15; and the high-pressure gas enters the precision MQL pump I-8 through the pipeline I-17 after exiting from the frequency generator I-15. In addition, the high-pressure gas enters the precision MQL pump I-8 through another outlet pipeline I-18 of the tee I-10; one end of the oil cup joint I-2 is in threaded connection, and the other end is in threaded connection with the lubricating pump fixing cover I-7; the lubricating pump fixing cover I-7 is connected with the precision MQL pump I-8 through the two fixing screws I-6 and fixed to the box body I-1 through the two fixing screws I-4 and the washer I-5; the volume of the high-pressure gas is adjusted by adjusting the air flow regulation knob I-9; the volume of the lubricating oil is adjusted by adjusting the oil regulation knob I-19; and finally, the lubricating oil is provided to the cutting mechanism IV by connecting the lubricating pump outlet joint I-20 with the nozzle joint IV-6. By arranging the frequency generator and the solenoid valve, the lubrication under different conditions can be effectively realized, such as dry cutting, casting type lubrication, MQL and nanofluid MQL conditions.

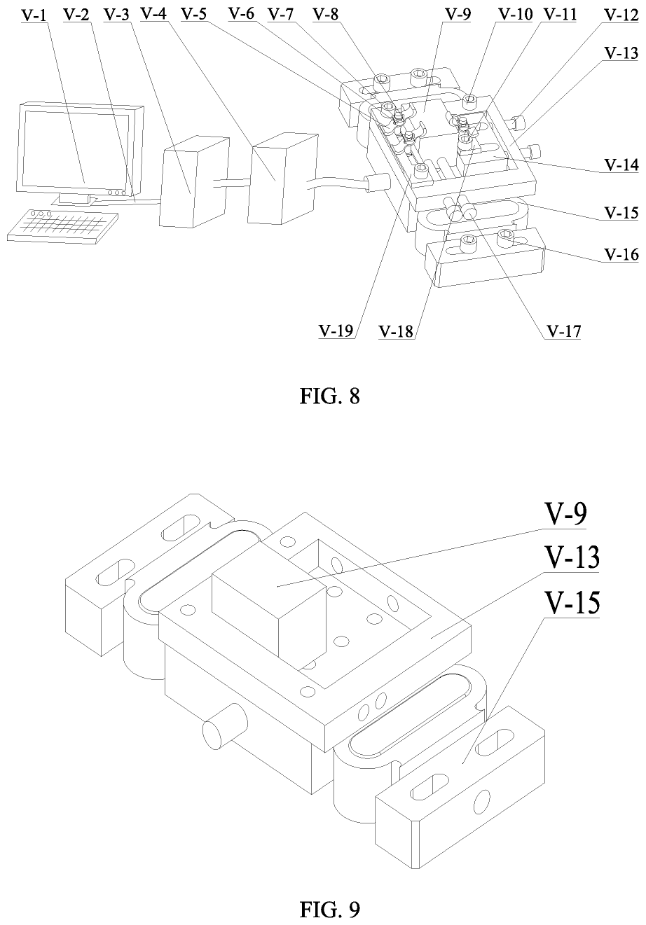

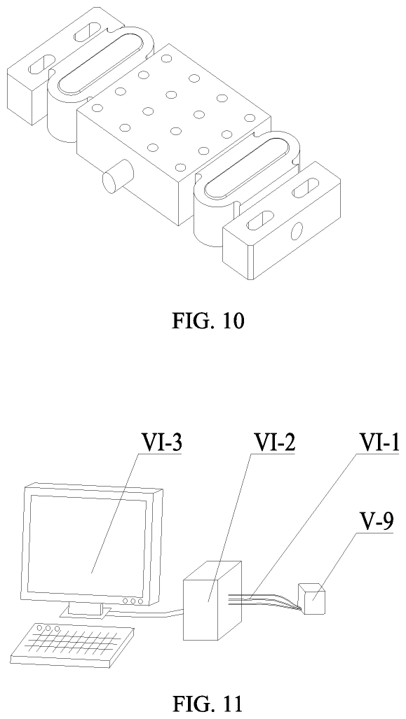

FIG. 8 is an axonometric drawing of a force measuring mechanism; FIG. 9 is a locating and clamping diagram of workpiece; and FIG. 10 is an axonometric drawing of a dynamometer.

Description is made in combination with FIGS. 8-10. A dynamometer V-15 is fastened on a workbench IV-11 with a screw V-16. A workpiece clamp V-13 is fixed on the workbench of the dynamometer V-15; the workpiece V-9 is placed on the workbench of the dynamometer V-15; and six degrees of freedom of the workpiece V-9 can realize the complete locating through the workpiece clamp V-13 and the workbench of the dynamometer V-15. An X axis direction of the workpiece V-9 is clamped with two locating screws V-12, and in a Y direction of the workpiece, the workpiece V-9 is, clamped with a workpiece clamp screw V-17. One surface of a locating block V-14 comes into contact with the side of the workpiece V-9; the other surface comes into contact with the two locating screws V-12; and the locating, screws V-12 are tightened to clamp the locating block V-14 in the X direction of the workpiece V-9. The workpiece V-9 is clamped with three pressing plates V-5 in a Z direction, and the three pressing plates V-5 constitute a self-adjusting pressing plate by virtue of a flat plate V-18, a flat plate V-19, a cylindrical gasket V-6, a pressing plate screw V-8 and a pressing plate nut V-7. When the length, width and height of the workpiece V-9 are changed, adjustable equipment can be realized through the two clamp screws V-17, the two locating screws V-12 and the three pressing plates V-5, thereby meeting the requirements of change in size of the workpiece V-9. The locating block V-14 is clamped with a small pressing plate screw V-11 and the locating screw V-12. When the workpiece V-9 suffers from a cutting force, a measurement signal is transmitted to an information collector V-3 through an amplifier V-4 and finally to a computer V-1 through a wire V-2, and the size of the cutting force is displayed

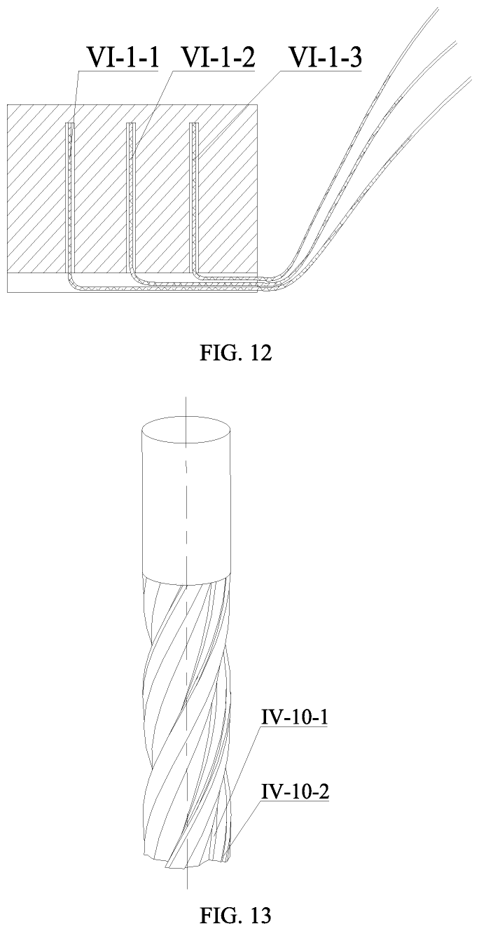

FIG. 11 is a diagram of a temperature measurement system, and FIG. 12 is a section view of the workpiece.

Description is made in combination with FIGS. 11-11 Three blind holes are provided in the workpiece. Three thermocouples VI-1-1, VI-1-2 and VI-1-3 are located in the blind hole of the workpiece. A working end of the thermocouple is located at 0.5 mm below the surface of the workpiece V-9. When the second tool cuts the workpiece to a certain extent and cuts the thermocouple, the thermocouple detects the temperature of the second tool, and transmits a heat signal to the information collector, and finally, the temperature of the working end of the thermocouple is displayed on the computer. The three thermocouples can be adopted to measure the cutting heat in an end face milling for three times, to obtain three sets of measured data, thereby saving the time and avoiding the error arising from the installation difference.

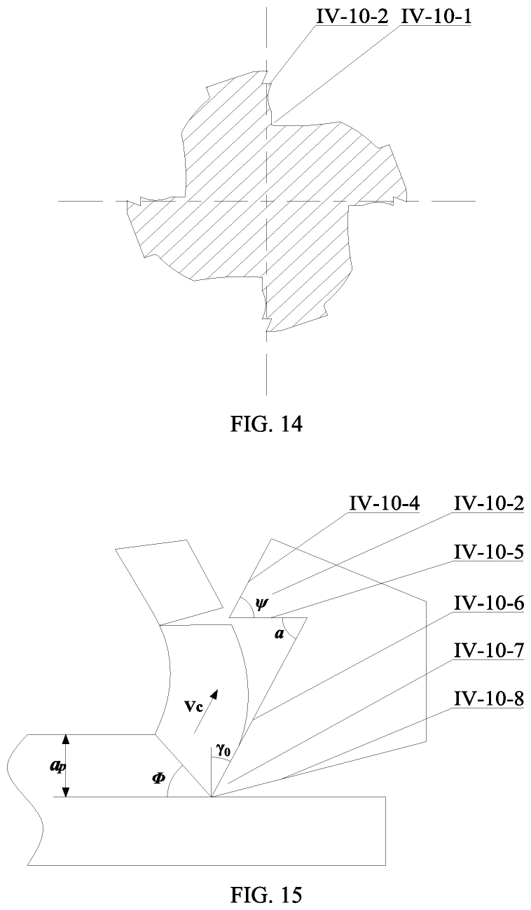

FIG. 13 is a three-dimensional diagram of a tool with a chip breaking edge. FIG. 14 is a section view of a tool in Embodiment 1 of a chip breaking edge. FIG. 15 is a schematic diagram in Embodiment 1 of a chip breaking edge.

Description is made in combination with FIGS. 13-15. In Embodiment 1 of a chip breaking edge, the flank face IV-10-5 of the chip breaking edge forms an angle α with the main cutting edge (the second tool for cutting the workpiece) IV-10-7 and forms an angle φ with the rake face IV-10-4 of the chip breaking edge, namely, a tool nose angle of the chip breaking edge. During milling machining, the main cutting edge IV-10-7 cuts the workpiece to form the chips: the chips flow out along the rake face IV-10-6 of the main cutting edge; the flow velocity of the chips is ν_{c}; the chips are cut off by the chip breaking edge IV-10-2 in the process of flowing out along the rake face IV-10-6 of the main cutting edge, cut into smaller chippings and then discharged from a chip groove IV-10-1 by the rotation of the tool with the chip breaking edge. When the rake angle γ₀ is relatively large, the angle α should also be relatively large, and on the contrary, when the rake angle γ₀ is relatively small, the angle α should be relatively small. The chip breaking edge is suitable for the milling machining when the depth of cut αₚ is large.

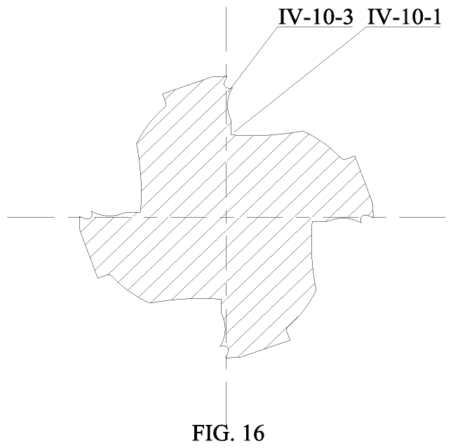

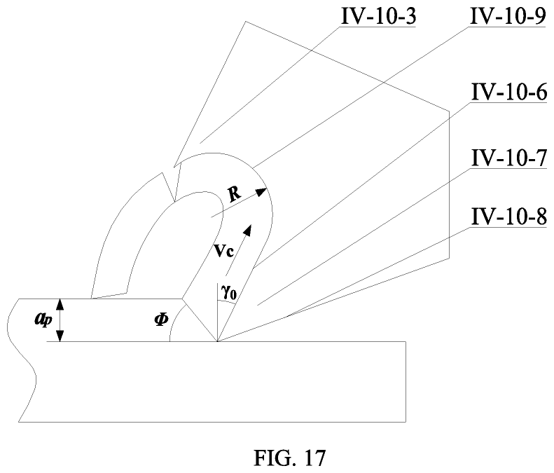

FIG. 16 is a section view of a tool in Embodiment 2 of a chip breaking edge, and FIG. 17 is a schematic diagram in Embodiment 2 of a chip breaking edge.

Description is made in combination with FIGS. 16-17. The tool nose IV-10-7 cuts the workpiece to form the chips; the chips flow out along the rake face IV-10-6 of the main cutting edge; and the flow velocity of the chips is ν_{c}. According to the chip-curling principle, the chips bend according to the shape of a chip-curling surface IV-10-9 of the chip breaking edge in the process of flowing out along the rake face IV-10-6 of the main cutting edge, wherein the radius of the chip-curling surface IV-10-9 of the chip breaking edge is R; and the chip breaking edge IV-10-3 applies a certain binding force to the flowing chips, so that the strain of the chips is increased, and the curling radius of the chips is decreased, thereby forming a C shape. After the chips are severely deformed through a deformation zone I and a deformation zone II, the hardness is increased, the plasticity is reduced and the performance is brittle. During the discharge of the chips, when the chips encounter the flank face of the tool, a transitional surface on the workpiece, or a surface to be processed and other obstacles, if the strain of a part exceeds a breaking strain value of the chip material, the chips may be broken off The selection of the radius R of the chip-curling surface IV-10-9 of the chip breaking edge is related to the material performance. If the brittleness of the material is smaller, the R value is larger, and the degree of chip curling is larger, which is more beneficial to the chip breaking. The chip breaking edge is suitable for milling machining when the depth of cut αₚ is relatively small. Meanwhile, if the brittleness of the workpiece material is larger (if the breaking strain value is smaller), the chip thickness is larger and the curling radius of the chips is smaller, then the chips are easier to break off.

The size diameters in Embodiment 1 of the chip breaking edge and Embodiment 2 of the chip breaking edge shall adapt to the cutting dosage; otherwise, the chip breaking effect may be affected.

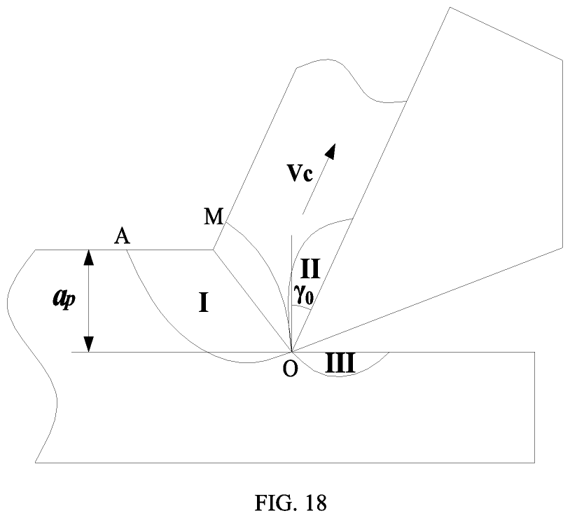

FIG. 18 is a diagram of a metal cutting deformation zone. When the metal material is cut with the tool on a machine tool, a cutting layer is extruded by the rake face of the tool; and the cutting zone has three different deformation zones, which, are the deformation zone I, the deformation zone II and a deformation zone III, wherein, the deformation zone I is a zone between OA and OM in the cutting layer, an OA line is a start line for shear slip of metal, and an OM line is a terminating line for grain shear slip of the metal, which is a zone to generate the plastic deformation and the shear slip. The deformation zone I is the largest deformation zone; the grain is lengthened; and meanwhile, a lot of cutting heat is generated, but the zone is very narrow. which is probably only 0.2-0.02 mm wide. The deformation zone II is a contact zone of the tool/chips, and the metal material discharged by the rake face through the deformation zone I forms the deformation zone II at the place close to the rake face. In the area, under the friction and extrusion with the rake face, the deformation degree of the metal in the cutting layer is increased, the fibration is formed in a direction parallel to the rake face, and even, a stagnant layer sometimes appears. The deformation zone III is a contact zone of the tool/chips, which is a zone to generate the deformation of the processed surface layer close to the cutting edge due to the extrusion and friction of the cutting edge and the flank face, and the metal in the cutting layer is further suffered from the friction and extrusion of the flank face to generate the elastic resilience, which has a large influence on the quality of the finished surface of metal. The three deformation zones have their characteristics, and have interaction and mutual influence. Various physical phenomena in the cutting process are closely related to the deformation of the metal layer.

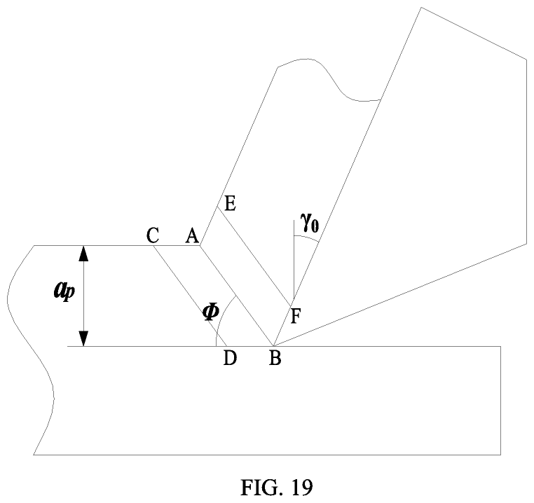

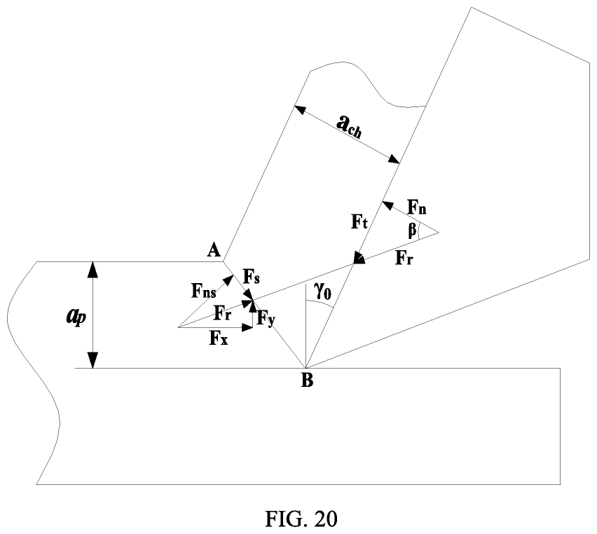

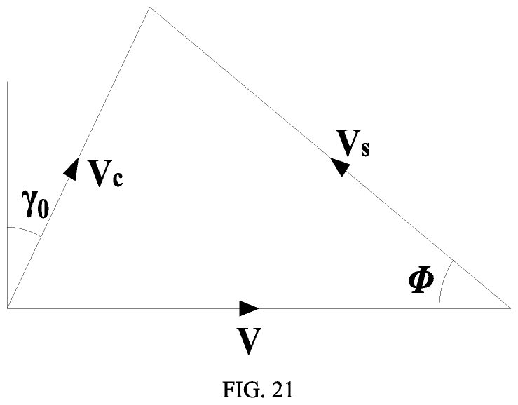

FIG. 19 is a schematic diagram of a shear zone; FIG. 20 is a diagram for stress analysis of a shear zone; and FIG. 21 is a diagram of a velocity model.

Description is made in combination with FIGS. 19-21. In the deformation zone I, simple analysis is conducted to the chip formation process according to a Merchant cutting model. It is assumed that the material is sheared along the shear plane expanded from a cutting edge to a free surface of the workpiece, namely, the deformation zone I in the metal cutting is taken as the shearing surface. An angle between the shearing surface and the cutting speed direction is called the shear angle. The size of the shear angle can be used for analyzing the degree of chip deformation, and calculating the cutting force. The shear deformation is generated in a zone. The material in the cutting layer generates the plastic deformation from a CD surface, namely, an initial shear plane of the deformation zone I; and the deformation of an EF surface is stopped. The EF surface is a terminating shear plane of the deformation zone I. At this time, the shear strain shall reach the maximum. The shear strains on CD, AB and EF surfaces shall be respectively:

$${γ}_{CD} = 0 , {γ}_{AB} = \frac{cos {γ}_{0}}{2 sin φ cos ( φ - {γ}_{0} )} , {γ}_{EF} = \frac{cos {γ}_{0}}{sin φ cos ( φ - {γ}_{0} )} \qquad ( 1 )$$

Plastic work W₁ of the deformation zone I: W₁=k_{AB}·ϵ̅_{AB}, wherein k_{AB} is the shear strain on the shear plane AB, and ϵ̅_{AB} is an average strain on the AB.

$${\overline{ɛ}}_{AB} = \frac{{γ}_{EF}}{2 \sqrt{3}} = \frac{cos {γ}_{0}}{2 \sqrt{3} sin φ cos ( φ - {γ}_{0} )} \qquad ( 2 )$$

The shear zone is surrounded by the two parallel planes CD and EF, and the chips are formed in the shear zone. To simplify the calculation, it is assumed that the formation of the chips is continuous, and appropriately in a plane strain state.

The strain rate of the shear zone is required, and the following relational expression can be obtained according to the Von Mises stress yield criterion:

ϵ=γ/\sqrt{3}, \dot{ϵ}=\dot{γ}/\sqrt{3} (3)

Wherein ϵ and \dot{ϵ} are respectively the strain and the strain rate of the shear zone; γ and \dot{γ} are respectively the shear strain and the shear strain rate of the shear zone. Any point is taken in the shear zone to calculate the strain and the strain rate of such point in the shear zone, and then, the shear strain and the shear strain rate along the shearing surface AB can be obtained.

Since upper and lower boundaries CD and EF in the shear zone and the shearing surface AB are parallel to each other, the average shear strain rate can be expressed with the equation of obtaining the flow velocity, namely, as shown in the following formula:

$${\overline{γ}}_{avg} = \sqrt{{( \frac{δ {v}_{z}}{{δ}_{y}} + \frac{δ {v}_{y}}{{δ}_{x}} )}^{2} + 4 {( \frac{δ {v}_{x}}{{δ}_{y}} )}^{2}} \qquad ( 4 )$$

Wherein γ̅_{avg} is the average shear strain rate, and νₓ and ν_{y} are the flow velocity of a particle in an X and Y direction. In order to calculate the average shear strain rate, Δνₓ=−νₛ·cos φ, Δν_{y}=νₛ·sin φ, Δx=Δs₁/sin φ, Δy=Δs₁/cos φ is taken, wherein νₛ is the shear speed, and Δs₁ is the width of the shear zone, namely, a distance between the boundaries CD and EF of the shear zone. In order to obtain the average shear strain, the shear speed νₛ should be obtained.

The average shear strain rate is:

$${\overline{γ}}_{avg} = \frac{v cos {γ}_{0}}{Δ {s}_{1} cos ( φ - {γ}_{0} )} \qquad ( 5 )$$

The average shear strain γ_{AB} along the shear line AB can be expressed with the product of the average shear strain rate and the time that the particle passes through the shear zone, as shown in the following formula:

$${γ}_{AB} = {\overline{γ}}_{avg} \cdot \frac{Δ x}{2 v} = \frac{v cos {γ}_{0}}{Δ {s}_{1} cos ( φ - {γ}_{0} )} \cdot \frac{Δ x}{2 v} = \frac{cos {γ}_{0}}{2 sin φ cos ( φ - {γ}_{0} )} \qquad ( 6 )$$

So a strain equation along an AB line is:

$${ɛ}_{AB} = \frac{1}{2 \sqrt{3}} \frac{cos {γ}_{0}}{cos ( φ - {γ}_{0} ) sin φ} \qquad ( 7 )$$

A strain rate equation along an AB line is:

$${\dot{ɛ}}_{AB} = \frac{1}{\sqrt{3}} \frac{{cos}^{2} {γ}_{0}}{{cos}^{2} ( φ - {γ}_{0} )} \frac{v}{{a}_{c}} \qquad ( 8 )$$

The shear angle φ in the above formula can be determined by the following formula.

$$φ = arc tan \frac{cos {γ}_{0}}{ξ - sin {γ}_{0}} \qquad ( 9 )$$

Wherein ξ is the deformation coefficient of the material and related to the material, and γ₀ is the rake angle of the tool.

The plastic deformation of the shear zone increases the temperature of the shearing surface, and the temperature change value ΔT_{sz} of the shear zone related to the shear force can be calculated by a formula (10).

$$Δ {T}_{sz} = \frac{1 - {β}_{T}}{ρ {Sa}_{c} {a}_{w}} \frac{{F}_{s} cos {γ}_{0}}{cos ( φ - {γ}_{0} )} \qquad ( 10 )$$

Wherein β_{T} value is:

$$\begin{matrix}{β}_{T} = 0.5 - 0.35 log ( {R}_{T} tan φ ) & 0.04 \leq {R}_{T} tan φ \leq 10.0 \\ {β}_{T} = 0.3 - 0.15 log ( {R}_{T} tan φ ) & {R}_{T} tan φ > 10.0\end{matrix} \} ;$$

R_{T} is the coefficient of dimensionless heat:

$${R}_{T} = \frac{ρ {SVa}_{c}}{K} ;$$

ρ is the density of the workpiece material (Kg/m³); K is the thermal conductivity of the workpiece piece (m²·° C.); S is specific heat (g·° C.); and V is the cutting speed.

So, the expression of the average temperature T_{AB} of the shearing surface is:

T_{AB}=T_{w}+ηΔT_{sz} (11)

Wherein T_{w} is the environmental temperature (° C.), and η is the coefficient of converting the plastic work to the heat, and is 0.7.

The flow stress equation along the AB line is:

$${k}_{AB} = \frac{1}{\sqrt{3}} {{σ}_{0} ( 1 + \frac{{ɛ}_{ab}}{{ɛ}_{0}} )}^{n} {( \frac{{{ɛ}^{\dot{\_}}}_{ab}}{{{ɛ}^{\dot{\_}}}_{0}} )}^{m} {( 1 - \frac{{T}_{AB}}{{T}_{m}} )}^{l} \qquad ( 12 )$$

Wherein σ₀ is an initial yield stress (1000 MPa); ϵ₀ is an initial strain

$${ɛ}_{0} = \frac{{σ}_{0}}{E} ;$$

n is a strain index (0.1); \overline{\dot{ϵ}} is a strain speed; \overline{\dot{ϵ}}₀ is a yield strain speed; m is a strain speed index (0.0143); T is a cutting temperature; Tₘ is a melting temperature (related to the material); and 1 is a temperature softening coefficient (0.75).

The shear force on a shear plane is:

$${F}_{s} = {k}_{AB} {l}_{AB} {a}_{w} = \frac{{k}_{ab} {a}_{p} {a}_{w}}{sin φ} \qquad ( 13 )$$

Wherein k_{AB} is the shear force along the AB line; I_{AB} is the length of the shearing surface AB; and α_{w} is the cutting width.

Three speeds are provided in the cutting process, which are respectively the cutting speed v, the cutting speed v_{c} and the shear speed vₛ. The cutting speed is a linear speed of the first tool, and according to the continuous conditions, the three speeds are connected end to end to form a closed triangle. The equations of the cutting speed and the shear speed are:

$$\begin{matrix}{v}_{c} = \frac{sin φ}{cos ( φ - {γ}_{0} )} v & ( 14 ) \\ {v}_{s} = \frac{cos {γ}_{0}}{cos ( φ - {γ}_{0} )} v & ( 15 )\end{matrix}$$

A shear energy Es is expressed as the function of the shear force and the shear speed;

Eₛ=Fₛν₂ (16)

An angle θ of the shearing surface AB and a resultant force R of the shearing surface is called a cutting angle:

θ=φ+β−γ₀ (17)

It can be known from material mechanics that

$$φ + β - {γ}_{0} = \frac{π}{4} = θ .$$

A resultant tool force R of the shear zone can be expressed as:

$$R = \frac{{F}_{s}}{cos θ} = \frac{{k}_{ab} {a}_{p} {a}_{w}}{sin φ cos θ} \qquad ( 18 )$$

It can be inferred according to the force-balance principle on the shearing surface that, the relation among the cutting force (F_{c}) in the cutting speed direction, the cutting force (Fₜ) in the cutting thickness direction and the resultant tool force R is obtained.

$$\{ \begin{matrix}{F}_{c} = R cos ( β - {γ}_{0} ) \\ {F}_{t} = R sin ( β - {γ}_{0} )\end{matrix} \qquad ( 19 )$$

In the deformation zone II, the chips generated by the metal formation in the cutting layer flow out along the rake face at the speed V_{c}, and the flow velocity of the chip bottom close to the rake face is much more lower than that of other parts of the chip, which is called a stagnation phenomenon. The chips in the layer are called the stagnant layer. Serious plastic deformation occurs in the thin area of the stagnant layer of the chips on the rake face, which is also called secondary plastic deformation. A bonding phenomenon occurs between a chip bottom surface and the rake face under the conditions of high temperature and high pressure, and a bonding part of the chip bottom surface on the tool and upper metal generate the internal friction. The chip thickness α_{ch} of the deformation zone, contact length l_{f} of the tool and the chips and the shear strain rate \dot{γ}_{HG} of the shear speed in the deformation zone are respectively:

$$\begin{matrix}{a}_{ch} = \frac{{a}_{c} cos ( φ - {γ}_{0} )}{sin φ} & ( 20 ) \\ {l}_{f} = \frac{{a}_{c} sin \frac{π}{4}}{sin φ sin ( \frac{π}{4} + φ - {γ}_{0} )} & ( 21 ) \\ {\dot{γ}}_{HG} = \frac{{V}_{c}}{δ \cdot {a}_{ch}} & ( 22 )\end{matrix}$$

Wherein δ is the ratio of the thickness of the deformation zone II of a tool-chip contact surface and the chip thickness α_{ch}, and δ=0.05.

The friction force F_{f} between the tool and the chips is:

$${F}_{f} = {K}_{HG} \frac{{l}_{f}}{2} {a}_{w} + \frac{1}{2} {K}_{HG} \frac{{l}_{f}}{2} {a}_{w} = \frac{3}{4} {K}_{HG} \frac{{l}_{f}}{2} {a}_{w} \qquad ( 23 )$$

Wherein K_{HG} is the shear flow stress of the deformation zone II, K_{HG}=σ_{HG}/\sqrt{3}.

Therefore, the energy consumed by the tools/chip contact zone is:

$${E}_{HG} = {F}_{f} {V}_{c} = \frac{3 {σ}_{HG} {l}_{f} {a}_{w} {V}_{c}}{4 \sqrt{3}} = \frac{\sqrt{3} {σ}_{HG} {l}_{f} {a}_{w} {V}_{c}}{4} \qquad ( 24 )$$

The average temperature of the chips is:

$$Δ {T}_{c} = \frac{{F}_{f} sin φ}{ρ {Sa}_{c} {a}_{w} cos ( φ - {γ}_{0} )} \qquad ( 25 )$$

The maximum temperature rises ΔT_{M} of the chips is:

$$log ( \frac{Δ {T}_{M}}{Δ {T}_{C}} ) = 0.06 - 0.195 δ {( \frac{{R}_{T} {a}_{ch}}{{l}_{f}} )}^{\frac{1}{2}} + 0.5 log ( \frac{{R}_{T} {a}_{ch}}{{l}_{f}} ) \qquad ( 26 )$$

Therefore, the average temperature Tᵢₙₜ of the chips is:

Tᵢₙₜ=T_{w}+ΔT_{sz}+0.7ΔT_{M} (27)

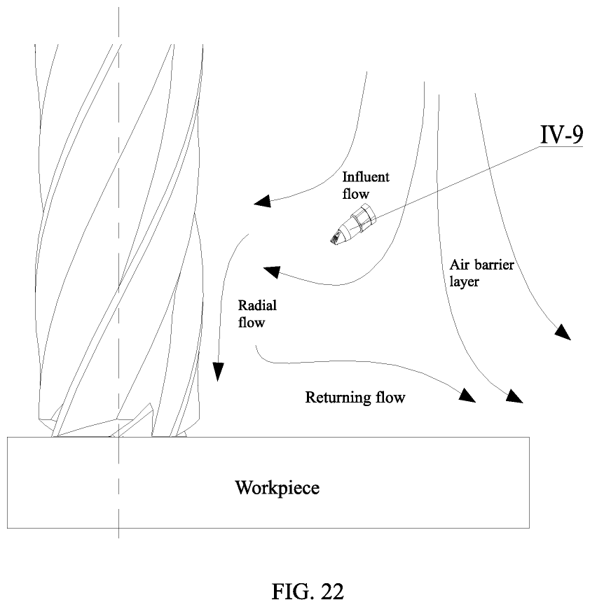

FIG. 22 is a schematic diagram of a milling air flow field.

Description is made according to FIG. 22. The air around the tool is originally still, but the tool that rotates at high speed may cause the air to flow; and the flow velocity of the air closer to the cutting-edge part is higher, thereby forming a closed “annular” area around the tool. The existence of this area has a blocking effect for the entry of the cutting fluid, and the cutting fluid cannot enter the tool/workpiece interface, thereby causing the machining burn. Therefore, an appropriate cutting fluid injection method is adopted, namely, the best position of the nozzle IV-9 can increase the proportion that the cutting fluid enters the processing zone, thereby playing a very important effect to improve the cooling and lubricating effects and improve the surface quality of the workpiece. The distribution of air flows around the milling zone can be seen from the figure: an air barrier is located at the outermost layer to hinder the cutting fluid from entering the cutting zone. Therefore, the position of the nozzle IV-9 shall not be outside the air barrier; influent flow is an airflow pointed to the surface of the tool in an airflow direction, which is beneficial to the entry of the cutting fluid. The cutting fluid follows into the airflow to reach the places around the tool and at a tool groove, thereby achieving the effect of transporting the cutting fluid. Further, the cutting fluid is transported into the cutting zone through a radial flow, and the radial flow is an airflow having an axial airflow direction; part of cutting fluid is adhered to the workpiece surface to form a layer of dense lubricating oil film, thereby playing a friction-reducing and anti-wear role, and cooling and lubricating the tool/workpiece interface; and part of cutting fluid flows out with the “returning flow”; the “returning flow” is an airflow having an airflow direction back on to the surface of the tool; the existence of the “returning flow” enables part of cutting fluid to flow out of the cutting zone, and simultaneously plays a role of hindering the cutting fluid from entering the cutting zone. Therefore, the injection of the cutting fluid shall be prevented from coming into contact with the “returning flow”. According to the measurement, when the axis of the nozzle IV-9 forms a certain angle (40°-50° and a certain distance (20-30 mm) with the workpiece surface, the air flow field may play a role of transporting the cutting fluid. Meanwhile, the “retuning flow” has the minimum obstruction for the cutting fluid, and the cutting fluid enters the cutting zone more easily and plays the best lubricating and cooling effects.

The above only describes preferred embodiments of the present application, and is not used for limiting the present application. For those skilled in the art, various changes and variations can be made to the present application. Any modification, equivalent replacement and improvement made within the spirit and principle of the present application shall be included in the protection scope of the present application.

We claim:

1. stool device for auxiliary chip breaking, comprising:
a cutting mechanism for cutting a workpiece, located above the workpiece;
a tool magazine mechanism, comprising a first rotating mechanism and a plurality of tools connected with the first rotating mechanism; and
a tool changing mechanism, comprising a second rotating mechanism and manipulators connected with the second rotating mechanism, and arranged between the tool magazine mechanism and the cutting mechanism, wherein the manipulators can be moved to select the tools from the tool magazine mechanism and clamp the tools to cut off chips generated by the cutting mechanism to cut the workpiece.

2. The tool device for auxiliary chip breaking according to claim 1, wherein the second rotating mechanism is connected with a moving mechanism, and the moving mechanism drives the second rotating mechanism and then drives the manipulators to do reciprocating motion towards the tool magazine mechanism;
or the second rotating mechanism is arranged in a motor box; the motor box is arranged on a bracket; and the motor box can do the reciprocating motion relative to the bracket, thereby driving the manipulators to do the reciprocating motion towards the tool magazine mechanism.

3. The tool device for auxiliary chip breaking according to claim 1, wherein the tool magazine mechanism comprises a tool pan; a plurality of first split rings are arranged in a circumferential direction of the tool pan; the tool is supported by the tool pan through the first split rings; the tools arranged in the plurality of first split rings have the same and/or different structure(s);
the tool is a first tool with a chip breaking edge, and an angle formed by a flank face of the chip breaking edge and a main cutting edge of a second tool of the cutting mechanism is in direct proportion to a rake angle of the second tool;
the radius of a chip-curling surface of the chip breaking edge of the first tool is inversely proportional to the brittleness of workpiece material;
further, a shear angle φ between a shearing surface of the workpiece and a cutting speed direction can be determined by the following formula:
$$φ = arc tan \frac{cos {γ}_{0}}{ξ - sin {γ}_{0}}$$
wherein ξ is the deformation coefficient of the material, and γ₀ is the rake angle of the second tool.

4. The tool device for auxiliary chip breaking according to claim 3, wherein two manipulators are arranged reversely, and the two manipulators are arranged horizontally;
the manipulators are provided with second split rings to match with the tool.

5. The tool device for auxiliary chip breaking according to claim 2, wherein the tool magazine mechanism and the cutting mechanism are supported by the bracket;
the cutting mechanism can realize up-and-down motion relative to the bracket.

6. A tool system for auxiliary chip breaking under different lubricating conditions, comprising the tool device for auxiliary chip breaking of claim 1;
a workbench, configured to fix the workpiece and arranged below the cutting mechanism;
a nozzle, arranged at the side of the second tool of the cutting mechanism; and
a lubricating mechanism, connected with the nozzle to provide lubricating oil.

7. The tool system for auxiliary chip breaking under different lubricating conditions according to claim 6, wherein the lubricating mechanism comprises a lubricating pump; the lubricating pump is connected with an oil cup and connected with a gas source processor through a solenoid valve; and the gas source processor is provided with an air inlet interface;
a frequency generator is arranged between the solenoid vale and the lubricating pump to control the frequency of gas inputted from the air inlet interface.

8. The tool system for auxiliary chip breaking under different lubricating conditions according to claim 6, wherein the nozzle is connected with a nozzle pipeline; the nozzle pipeline is connected with a lubricating oil pipeline through a nozzle interface; and a fixing cover is arranged at one side of the cutting mechanism through a sucker;
the nozzle axis has an angle of 40°-50° with a workbench surface; the nozzle has a distance of 20 to 30 mm from the surface of the installed workpiece;
the cutting mechanism comprises a motor box; the third rotating mechanism is arranged in the motor box to drive the second tool to rotate; and the sucker is arranged at the side of the motor box.

9. The tool system for auxiliary chip breaking under different lubricating conditions according to claim 6, wherein the workbench surface is provided with a workpiece clamp; a workpiece clamp opening is used for arranging a clamping slot of the workpiece; and a clamp screw is arranged at the side of the workpiece clamp to limit the workpiece;
a pressing plate is arranged at the side of the clamping slot of the workpiece clamp, and can realize the rotation relative to the workpiece clamp;
a locating block is movably arranged in the clamping slot and can be arranged at one side of the workpiece.

10. The tool system for auxiliary chip breaking under different lubricating conditions according to claim 9, wherein a dynamometer is arranged below the workpiece clamp, arranged between the workpiece clamp and the workbench, and connected with a controller;
the controller is connected with a temperature sensor; and the workpiece is provided with a blind hole so that the temperature sensor can be installed on the workpiece.
